(19) United States
(12) Patent Application Publication
(10) Pub. No.: US 2025/0249942 A1
(43) Pub. Date: Aug. 7, 2025

(54) WHEELED ACCESSORY FOR INSULATED CONTAINER

(71) Applicant: SharkNinja Operating LLC, Needham, MA (US)

(72) Inventors: Nicholas Lerwill, London (GB); Pierce Barnard, Manly (AU)

(21) Appl. No.: 18/431,110

(22) Filed: Feb. 2, 2024

(51) Int. Cl. B62B 1/26

(52) U.S. Cl. CPC B62B 1/26

(57) ABSTRACT

In general, a wheeled accessory for an insulated container is provided. In one embodiment, the wheeled accessory includes a wheel assembly configured to releasably fasten to a first side of an insulated container, and a handle assembly configured to releasably fasten to a second side of an insulated container. The handle can be used to lift the insulated container, causing one or more wheels on the wheeled accessory to contact a surface upon which the insulated container is resting, thereby allowing the handle to be used for pulling the container across the surface.

### FIELD

The present disclosure generally relates to wheeled accessories for transporting containers, such as an insulated container.

### BACKGROUND

Portable insulated containers, such as coolers, allow items such as beverages and foods to be kept cold while outdoors, in a vehicle, or otherwise outside of a refrigerator or freezer. Portable coolers typically have an insulated internal cavity in which a cooling agent, such as ice or reusable cooler packs, is placed to help cool the items in the cooler. When loaded with items and/or cooling agents, the portable cooler typically becomes very heavy to the point that it can be difficult or unsafe for a single person to lift and carry it. Some portable coolers exist with integrated features, such as wheels, that facilitate transportation, however these are typically cumbersome and often become undesirable when the portable cooler is not fully loaded. Other portable coolers can be combined with separate accessories but typically in a manner prone to detachment when the portable cooler is lifted up, such as when moving the portable cooler to or from a vehicle. Accordingly, it is desirable for a wheeled accessory that overcomes these deficiencies and securely integrates with a portable cooler when necessary.

### SUMMARY

In general, a wheeled accessory for transporting a container, such as an insulated container, is provided. In one embodiment, a wheel assembly is provided and can include a first elongate member and a second elongate member. A first end of each of the first and second elongate members may be configured to couple to a first side handle of the insulated container. The wheel assembly may also include an axle assembly. The axle assembly can include an axle housing coupled to a second end of each the first and second elongate members, an axle extending through the axle housing, a first wheel coupled to a first end of the axle and a second wheel coupled to a second end of the axle, and a bracket having a first container support configured to releasably couple to a first sidewall of the insulated container and a second container support configured to releasably couple to a bottom wall of the insulated container.

In one embodiment, the first container support can have a first set of openings and the second container support can have a second set of openings. The first set of openings can be positioned along a top edge of the first container support.

In some embodiments, the wheeled accessory can further include a handle assembly configured to couple to a second side handle of the insulated container. The handle assembly can include a mounting body, a third elongate member, a fourth elongate member, and a gripping member. A first end of each of the third and fourth elongate members may be coupled to the mounting body. The mounting body can be configured to releasably couple to the second side handle of the insulated container. A second end of each the third and fourth elongate members can be coupled to the gripping member. In some aspects, each the third and fourth elongate members can be configured to rotate between about 5 degrees and about 120 degrees relative to the mounting body.

In another embodiment, a portable storage system is provided and includes an insulated container and a wheel assembly releasably coupled to the insulated container. The insulated container can have a first pair of sidewalls, a second pair of sidewalls, and a bottom wall. An outer surface of a first sidewall of the first pair of sidewalls can include a first depression at a bottom end of the first sidewall. The bottom wall can have an outer surface with a second depression. The second depression may be connected to the first depression. The insulated container can further include a first side handle extending from an upper portion of the first sidewall. The wheel assembly can include an axle housing configured to releasably couple to the first and second depressions, two elongate members that each extend from the axle housing and releasably couple to the first side handle, and one or more wheels coupled to an axle extending through the axle housing. In some variations, the axle housing can include a bracket having a first container support releasably coupled to the first depression and a second container support releasably coupled to the second depression.

In some variations, the portable storage system can further include a handle assembly that is configured to couple to a second side handle of the insulated container. The handle assembly can have a mounting body, a third elongate member, a fourth elongate member, and a gripping member. A first end of each the third and fourth elongate members may be coupled to the mounting body, and a second end of each the third and fourth elongate members may be coupled to the gripping member. In some aspects, each of the third and fourth elongate members may be configured to rotate between about 5 degrees and about 120 degrees relative to the mounting body. The portable storage system can further include a first wheel coupled to a first end of the axle and a second wheel coupled to a second end of the axle.

In another embodiment of a portable storage system having an insulated container and a wheel assembly, the wheel assembly can have an axle housing, at least one elongate member coupled to the first side handle, and one or more wheels coupled to an axle extending through the axle housing. The axle housing can include a bracket having a first container support releasably coupled to the first depression and a second container support releasably coupled the second depression. The first container support can have a first set of openings and the second container supports comprises a second set of openings. The plurality of openings of the first container support may be positioned along an upper portion of the first container support. The first container support may be perpendicular to the second container support. In some variations, the portable storage system can further include a first set of fasteners extending through the first set of openings and a second set of fasteners extending through the second set of openings. The first and second sets of fasteners can be parallel to each other.

### BRIEF DESCRIPTION OF DRAWINGS

This disclosure will be more fully understood from the following detailed description taken in conjunction with the accompanying drawings, in which:

FIG. 1A is a perspective view of one embodiment of a portable storage system;

FIG. 1B is another perspective view of the portable storage system shown in FIG. 1A;

FIG. 1C is a side view of the portable storage system shown in FIG. 1A;

FIG. 1D is a bottom view of the portable storage system shown in FIG. 1A;

FIG. 1E is another side view of the portable storage system shown in FIG. 1A;

FIG. 2A is bottom view of an insulated container of the portable storage system shown in FIG. 1A;

FIG. 2B is a top view of the insulated container shown in FIG. 2A;

FIG. 2C is a perspective view of the insulated container shown in FIG. 2A;

FIG. 3A is a perspective view of a portion of a wheel assembly of the portable storage system shown in FIG. 1A;

FIG. 3B is a bottom view of the wheel assembly shown in FIG. 3A;

FIG. 4A is a perspective view of a portion of an axle assembly of the portable storage system shown in FIG. 1A;

FIG. 4B is another perspective view of the axle assembly shown in FIG. 4A;

FIG. 5A is a perspective view of a handle assembly of the portable storage system shown in FIG. 1A; and

FIG. 5B is a front view of the handle assembly shown in FIG. 5A.

### DETAILED DESCRIPTION

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

In general, a wheeled accessory for releasably coupling to a container, e.g., an insulated container, is provided. The container and wheeled accessory together can define a portable storage system. In particular, the wheeled accessory can have a wheel assembly and a handle assembly, each configured to releasably couple a container. When secured to the container, the handle can be used to elevate a side of the container, thereby causing the one or more wheels on the wheel assembly to contact the surface upon which the container is resting, thus allowing the portable storage system to be rolled across the surface and transported.

The insulated container described herein is configured to store and/or transport items in a thermally stable environment, however a person skilled in the art will appreciate that the container can have a variety of configurations and need not be insulated. In the embodiments disclosed herein, the insulated container includes a cavity and a lid configured to cover the cavity. The cavity, which may be referred to as a storage compartment, can be configured to contain goods, cooling agents (e.g., ice), or a combination thereof. The storage compartment may be defined by one or more walls arranged in a shape such as a rectangle, a circle, a triangle, or a combination thereof. In certain embodiments, a volume of the storage compartment may be between about 1 L and about 100 L, about 20 L and about 80 L, about 40 L and about 70 L, or about 50 L and about 60 L, including about 40 L, about 50 L, or about 60 L. In some variations, the insulated container can have a plurality of storage compartments, which may or may not be thermally isolated from one another. In variations with a plurality of storage compartments, each of the storage compartments may have the same volume or different volumes. Further descriptions and variations of insulated containers are provided in U.S. patent application Ser. No. 18/490,122, filed on Oct. 19, 2023 and titled “Method of Manufacturing an Insulated Container,” the entire contents of which are incorporated herein by reference.

The wheeled accessory can also have various configurations. In an exemplary embodiment, the wheel assembly includes one or more elongate members (e.g., shafts) coupled to an axle assembly. The axle assembly can have a bracket, an axle, and one or more wheels coupled to the axle. The axle assembly can be configured to releasably couple to the insulated container, such as to a first end of the insulated container. The handle assembly can have one or more elongate members and a gripping member. The one or more elongate members of the handle assembly can be configured to releasably couple to the insulated container, such as to a second end of the insulated container, where the first end is opposite the second end. With or without the handle assembly, a user may lift the second end to tilt the insulated container. In such a tilted configuration, the one or more wheels may contact the ground. In this manner, the insulated container may be transported (e.g., rolled) along the ground, such as by pulling on the gripping member, due to the rotation of the one or more wheels that are in contact with the ground.

The wheeled accessory described herein may provide one or more benefits to the user. For example, rolling the insulated container along the ground via the wheel assembly may facilitate transportation of heavy loads and/or loads that may otherwise strain the user. As another example, the wheeled accessory described herein may be configured to stay attached to the insulated container even when the insulated container is lifted. In particular, one or more fasteners may be used to releasably couple the wheeled accessory to the insulated container such that the wheeled accessory stays securely coupled to the insulated container. Advantageously, the secure coupling may enable a user to move the insulated container up and down, such as in and out of a vehicle, without the wheeled accessory detaching. Furthermore, the secure coupling may facilitate transporting the insulated container over various terrain types (e.g., gravel, dirt, sand). The one or more fasteners can be easily attached or detached by a user. For example, a user may easily attach and/or detach the wheel assembly from the insulated container without lifting up the insulated container. For example, the wheel assembly may be attached to one or more sides of the insulated container such that the wheel assembly may not extend below a plane defined by a bottom surface of the insulated container. Advantageously, this functionality may be particularly useful when the insulated container already contains items which may be heavy and could otherwise result in significant strain to the user.

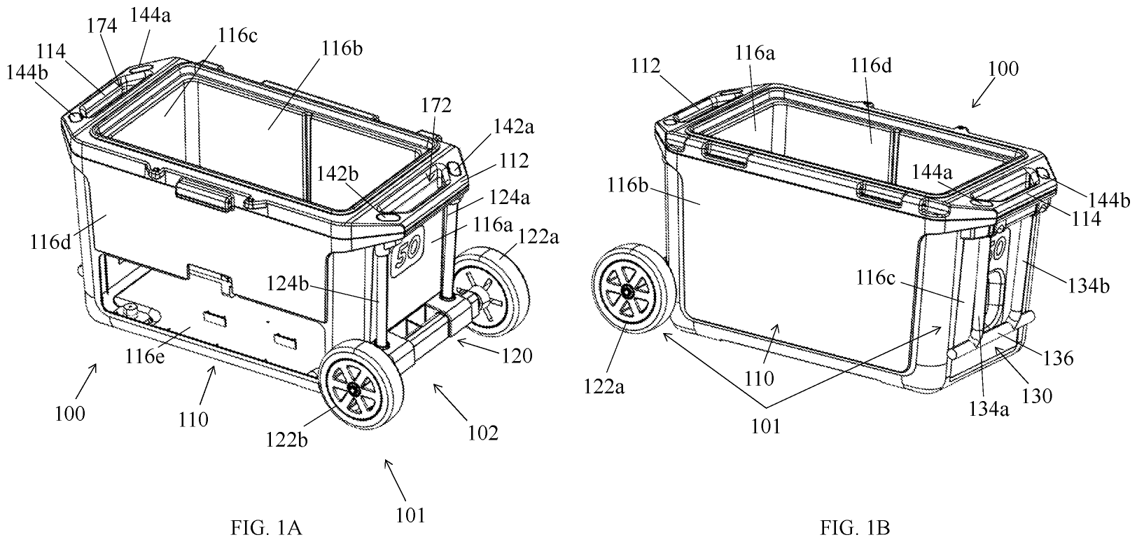

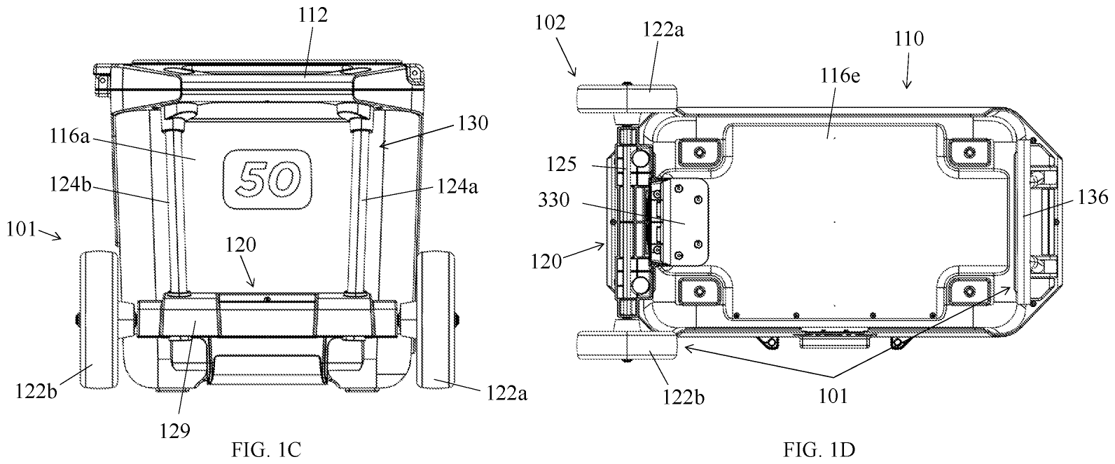

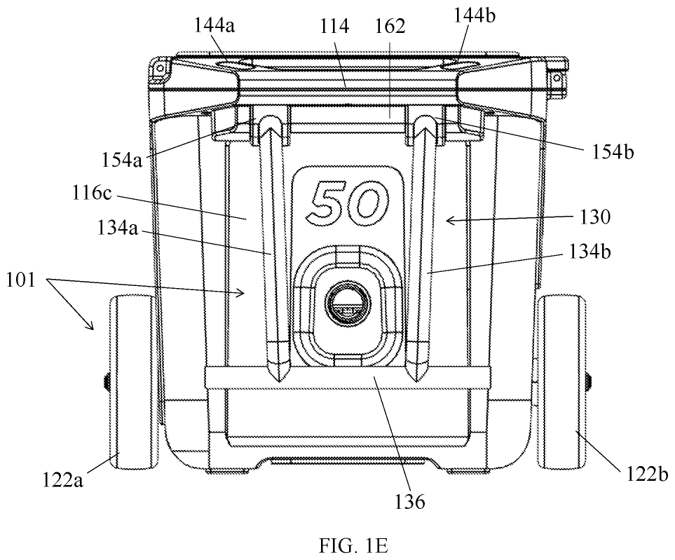

FIGS. 1A-1E illustrate an exemplary embodiment of a portable storage system 100. The illustrated portable storage system 100 includes an insulated container 110 releasably coupled to a wheeled accessory 101 having a wheel assembly 102 and a handle assembly 130. The insulated container 110 can have a variety of configurations, but in the illustrated embodiment it has a plurality of walls including a first sidewall 116a, a second sidewall 116b, a third sidewall 116c, a fourth sidewall 116d, and a bottom wall 116e. The first sidewall 116a may define a first end of the insulated container and the third sidewall 116c may define a second end of the insulated container. The first sidewall 116a and the third sidewall 116c may form a first pair of sidewalls, where each of first sidewall 116a and the third sidewall 116c may comprise a similar width and height. The second sidewall 116b and the fourth sidewall 116d may form a second pair of sidewalls, where each of second sidewall 116b and the fourth sidewall 116d may comprise a similar width and height. As shown, the width of the first pair of sidewalls is different, e.g., less than, than the width of the second pair of sidewalls, such that the container is generally rectangular.

The insulated container 110 can also include one or more side handles. For example, the illustrated insulated container 110 has a first side handle 112 and a second side handle 114. The first side handle 112 extends across an upper portion of the first sidewall 116a and the second side handle 114 extends across an upper portion of the third sidewall 116c. Each of the side handles 112, 114 may be used by a user to pick up, push, pull, or otherwise move the insulated container. For example, each of the side handles 112, 114 may define an opening through which a user may position at least a portion of their hand. As shown, the first side handle 112 has a first opening 172 and the second side handle 114 has a second opening 174. Each of the openings 172, 174 may be sized to receive one or more fingers or other portions of a user's hand.

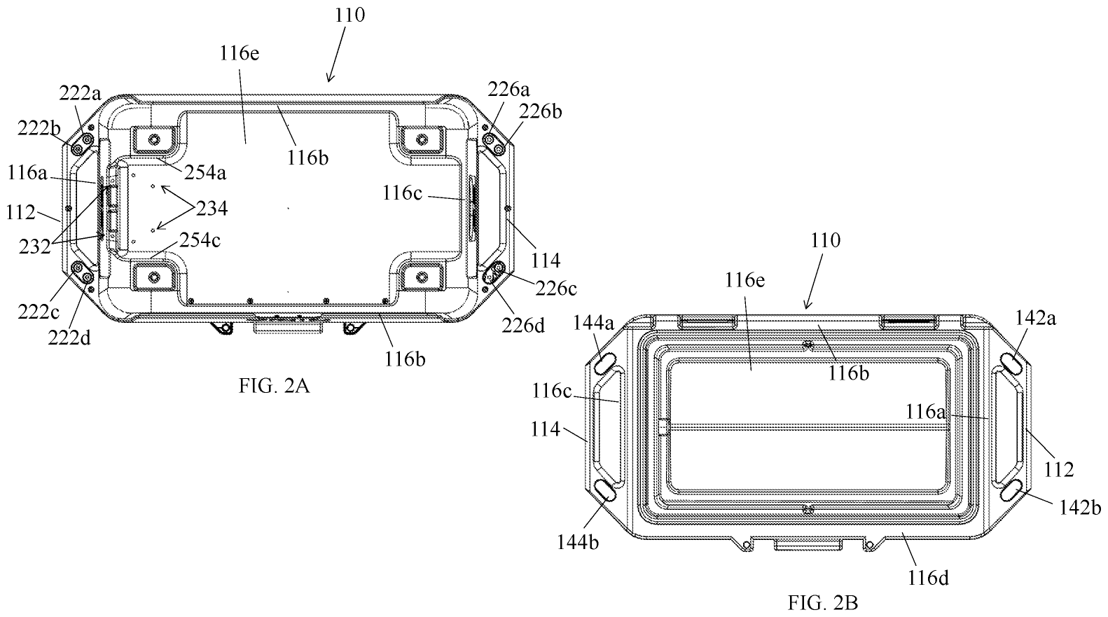

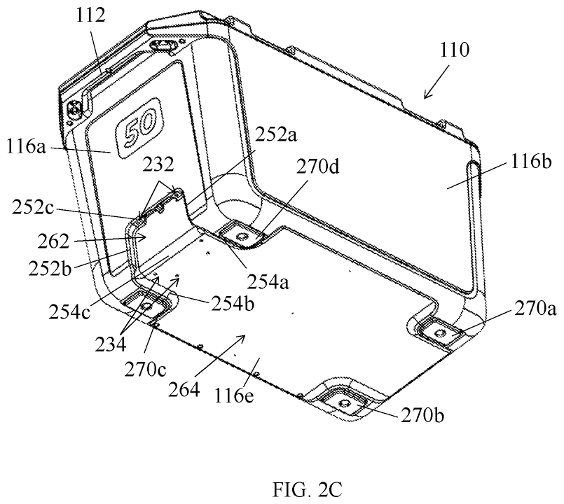

Additionally, each of the side handles 112, 114 can have one or more features configured to releasably receive one or more elongate members of the wheeled accessory 101, discussed further below. For example, the first side handle 112 can have a first receiver 142a and a second receiver 142b. Each of the first and second member receivers 142a, 142b may be configured to receive distinct elongate members of the wheel assembly 102. The second side handle 114 can similarly have a first receiver 144a and a second receiver 144b. Each of the first and second member receivers 144a, 144b may be configured to receive portions of the handle assembly 130. The receivers 142a-142b and 144a-144b will be described further with reference to FIGS. 2A-2B.

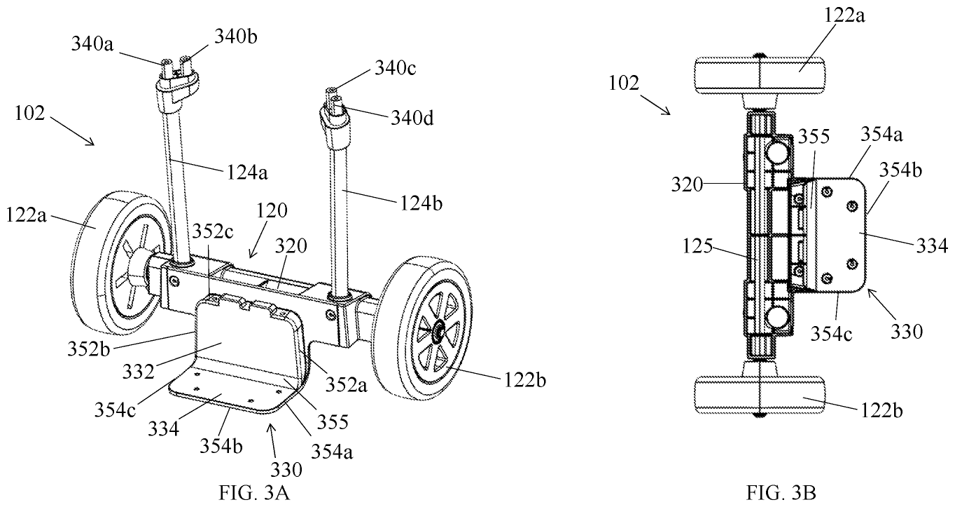

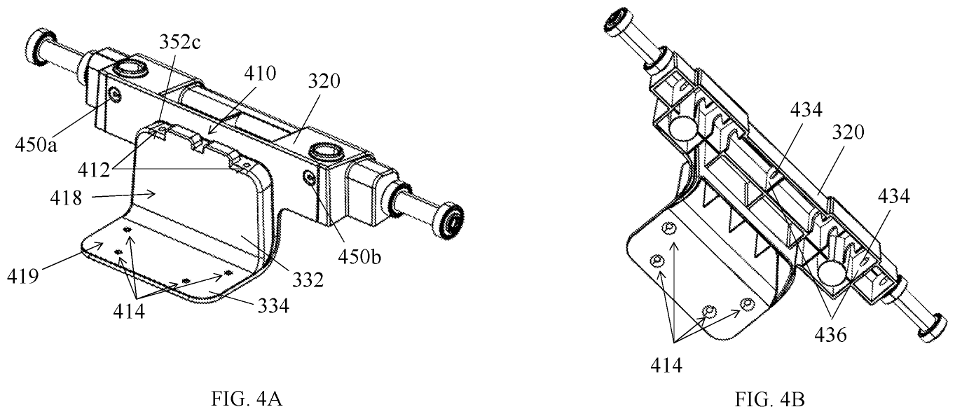

The wheel assembly described herein can have a variety of configurations, but in general can have one or more elongate members coupled to an axle assembly. Each of the one or more elongate members may be releasably coupled to the insulated container, such as by a friction fit, a mechanical fastener (e.g., screw, nail), a rope, a tie, or a combination thereof. For example, as shown in FIGS. 1A and 1B, the wheel assembly 102 has a first elongate member 124a, a second elongate member 124b, and an axle assembly 120. The axle assembly 120 extends between and is securely coupled to a second end of each of the first and second elongate members 124a, 124b, such that the axle assembly 120 and the elongate members 124a, 124b form a generally U-shaped member. A first end of each of the first and second elongate members 124a, 124b can be releasably coupled to the first side handle 112. The axle assembly 120 can be positioned adjacent to a bottom portion of the first sidewall 116a. The axle assembly 120 can further include a bracket 330 configured to couple to each of the first sidewall 116a and the bottom wall 116e of the container. The bracket 330 will be described in further detail with reference to FIGS. 3A-3B and 4A-4B.

The axle assembly may be configured to facilitate transportation of the insulated container in one or more directions. For example, the axle assembly 120 can have an axle housing 129, an axle 125, a first wheel 122a, and a second wheel 122b. The axle 125 can be positioned within the axle housing 129. The first wheel 122a can be coupled to a first end of the axle 125 and the second wheel 122b can be coupled to a second end of the axle 125. Each of the axle 125, first wheel 122a, and second wheel 122b may rotate about an axis defined by the axle 125. When mated to the container, the first wheel 122a can be positioned adjacent to the second sidewall 116b and the second wheel 122a can be positioned adjacent to the fourth sidewall 116d. The wheels 122a, 122b can be positioned such that neither of the wheels 122a, 122b contact the ground while the bottom wall 116e is flat against the ground. The wheels 122a, 122b may contact the ground when the second end of the insulated container 110 is lifted. Accordingly, the insulated container may move in a forward, backward, or sideways direction when the wheels are in contact with the group. In some variations, the axle assembly 120 may have alternative means of movement other than one or more wheels, such as a continuous track (e.g., tank treads) or a ski. The axle assembly 120 may move in response to a force provided by a user, such as a pulling or pushing force. In some variations, the axle assembly 120 may include one or more motors, such that the axle assembly 120 may move without a force directly applied by a user. The axle assembly 120 is described in further detail below with reference to FIGS. 3A and 3B.

Each insulated container can further include one or more external features that correspond to the wheel assembly. For example, the insulated container 110 can have a depression (e.g., cut-out, valley, mortise, opening) on one or more external surfaces that may be configured to receive a portion of the wheel assembly 102, such as the bracket 330 and/or one or more elongate members 124a. 124b. FIGS. 2A-2C illustrate the insulated container 110 without the wheeled accessory 101 coupled thereto. As shown, the first sidewall 116a of the insulated container 110 has a first depression 262 that can be configured to receive a portion of a wheel assembly (e.g., a first container support of a bracket). The first depression 262 may be positioned in a bottom portion of the first sidewall 116a. The first depression 262 includes a first sidewall 252a, a second sidewall 252b, and a third sidewall 252c. One or more of the sidewalls 252a-252c can be angled. In an exemplary embodiment, the sidewalls 252a, 252b are angled such that a first end of each of the sidewalls 252a, 252b is closer than a second end of each of the sidewalls 252a, 252b. Each of the first ends of the sidewalls 252a, 252b is adjacent a second depression 262. The second depression 264 can be configured to receive a portion of a wheel assembly (e.g., a second container support of a bracket). The second depression 264 includes a first sidewall 254a and a second sidewall 254b. One or more of the sidewalls 254a, 254b can be angled. For example, a first end of each of the sidewalls 254a, 254b is closer than a second end of each of the sidewalls 254a, 254b. Each of the first ends of the sidewalls 254a, 254b is adjacent the first depression 262. In some variations, the insulated container 110 can have depressions on any side thereof. Furthermore, in some variations, the insulated container can have more than two depressions, such as 3, 4, 5, 6, or more depressions. Each of the depressions may be configured to receive the same wheel assembly or different wheel assemblies.

As shown in FIGS. 2A-2C, the first depression 262 may be connected to the second depression 264. That is, one or more rounded edges may be formed between the first depression 262 and the second depression 264. For example, as shown in FIG. 2C, a rounded edge 254c defines a transition between the first depression 262 and the second depression 264. The first and second depressions 262, 264 may be recessed from the outermost surface of the first sidewall 116a and bottom wall 116e, respectively, by a depth d. In an exemplary embodiment, the depth d can be between about 0.254 mm and about 25.4 mm. In some variations, the depth d can correspond to a thickness of the first and/or second container supports, respectively. Additionally, one or more of the depressions 262, 264 can have one or more openings configured to receive a fastener. For example, as shown in FIGS. 2A and 2C, the first depression 262 comprises a first plurality of openings 232. In the illustrated embodiment, the openings 232 are be positioned along the sidewall 252c (e.g., an upper wall) of the depression 262. The second depression 264 has a second plurality of openings 234. The illustrated second plurality of openings 234 are positioned near or adjacent to the first sidewall 116a.

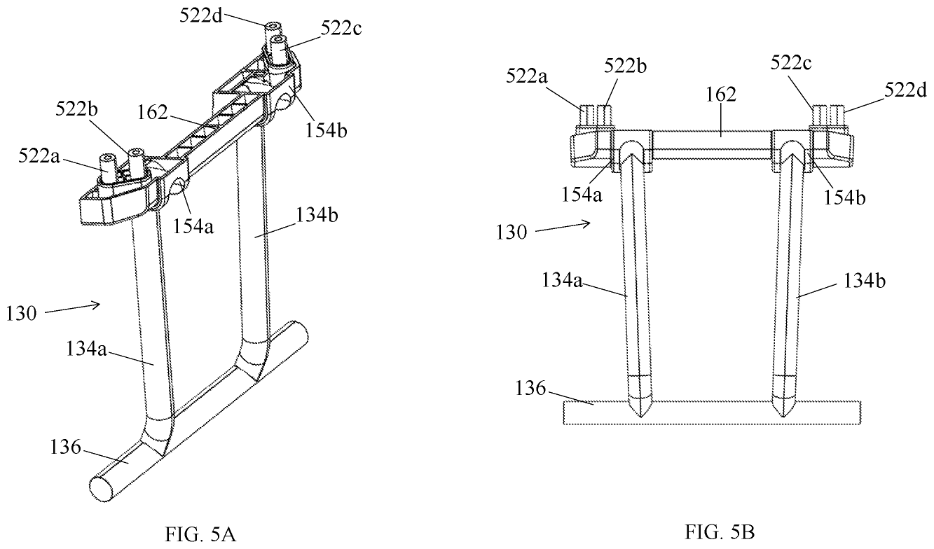

As further shown, one or more member receivers may be positioned on one or more of the side handles 112, 114 and each member receiver can have one or more mounting openings configured to receive an elongate member of a wheel assembly. In some aspects, the connections between the elongate members and the side handles 112, 114 can be in the form of a mortise and tenon-type connection. For example, the elongate members can each have one or more features corresponding to a tenon, and each of the side handles 112, 114 can have one or more features corresponding to a mortise. As shown in FIG. 2B, the side handle 112 has the first receiver 142a and the second receiver 142b. The first receiver 142a has a first mounting opening 222a and a second mounting opening 222b. The second receiver 142b has a third mounting opening 222c and a fourth mounting opening 222d. Each of the mounting openings 222a-222d may be configured to receive a mounting protrusion, such as the mounting protrusions described in detail below with reference to FIGS. 3A-3B and 5A and 5B. The first and second mounting openings 222a, 222b may be positioned on a first portion of the side handle 112 and third and fourth mounting openings 222c, 222d may be positioned on a second portion of the side handle 112. An intermediate portion of the side handle 112 positioned between the first and second portions may be configured to receive a user's hand, such that the user may grasp or otherwise handle the side handle 112.

Similar to the first handle 112, the second handle 114 can have the first receiver 144a and the second receiver 144b. The first receiver 144a can include a first mounting opening 226a and a second mounting opening 226b. The second receiver 144b can include a third mounting opening 226c and a fourth mounting opening 226d. Each of the mounting openings 222a-222d and 226a-226d may extend only partially through the respective receiver 142a-142b, 144a-144b. Accordingly, an upper surface of each receiver 142a-142b, 144a-144b may be smooth and/or coplanar with an upper surface of the respective side handle 112, 114. The mounting openings 222a-222d and 226a-226d will be described in more detail with reference to FIGS. 3A-3B and 5A-5B.

The insulated container 110 can further have one or more feet (e.g., stands, contact points, mounts) configured to contact a ground surface. For example, the illustrated insulated container 110 has a first foot 270a, a second foot 270b, a third foot 270c, and a fourth foot 270d. Each of the feet 270a-207d may be configured to contact a ground surface. In some variations, a flexible material, such as rubber, may be coupled to each of the feet 270a-207d to provide an elastic contact surface that may avoid scratching or otherwise damaging the ground surface when in contact therewith.

FIGS. 3A and 3B illustrate at least a portion of the wheel assembly 102 shown in FIGS. 1A-1E. In the illustrated embodiment, the wheel assembly includes the first elongate member 124a, second elongate member 124b, and the axle assembly 120. In an exemplary embodiment, the first and second elongate members 124a, 124b can have a length between about 50 mm and about 900 mm. The length of each of the first and second elongate members 124a, 124b may be the same as each other or different. The first and second elongate members 124a, 124b can each have a cross-sectional shape such as a circle, a rectangle, a triangle, an oval, or a combination thereof. The first and second elongate members 124a, 124b may be manufactured from a material configured to withstand the forces associated with transporting the insulated container described herein. For example, the first and second elongate members 124a, 124b may be manufactured from a plastic, a metal, or a combination thereof.

Each of the first and second elongate members 124a, 124b may further include one or more elements configured to releasably couple to a side handle. For example, as shown, the first elongate member 124a has a first mounting protrusion 340a and a second mounting protrusion 340b. Similarly, the second elongate member 124b has a third mounting protrusion 340c and a fourth mounting protrusion 340d. Each of the mounting protrusions 340a-340d may be configured to releasably couple to a corresponding opening of the side handle 112 described in reference to FIG. 2A. For example, the first mounting protrusion 340a may engage with the first mounting opening 222a, the second mounting protrusion 340b may engage with the second mounting opening 222b, the third mounting protrusion 340c may engage with the third mounting opening 222c, and the fourth mounting protrusion 340d may engage with the fourth mounting opening 222d. The mounting protrusions 340a-340d may be slid into the corresponding mounting openings 222a-222d, such that the components stay attached via friction. In some variations, additional or alternative means of fastening may be used, such as bolts, screws, nails, adhesives, ropes, ties, or a combination thereof.

In addition to the connections between the side handles and elongate members, the wheel assembly described herein may be coupled to the insulated containers at one or more other locations. For example, as shown in FIGS. 3A and 3B, the axle assembly 120 further includes a bracket 330 that can be coupled to the insulated container with one or more fasteners (e.g., screws, nails, bolts). The bracket 330 can have various configurations, but as shown in the illustrated embodiment the bracket 330 has one or more container supports. The container supports may be configured to couple to and/or support the insulated container. For example, the bracket 330 can have a first container support 332 and a second container support 334. The first container support 332 may be releasably coupled to the axle assembly 120 or, in some variations, may be integrally formed therewith. Each of the first and second container supports 332, 334 can have at least one smooth surface configured to non-destructively contact the insulated container. The respective container supports 332, 334 may be angled relative to each other. For example, an angle of the first container support relative to the second container support may be between about 5 degrees and about 160 degrees, about 20 degrees and about 135 degrees, about 45 degrees and about 120 degrees, about 60 degrees and about 100 degrees, about 80 degrees and about 100 degrees, or about 85 degrees and about 95 degrees, including about 80 degrees, about 85 degrees, about 90 degrees, or about 95 degrees. The angle is defined by a rounded surface 355 that extends between the container supports 332, 334. As shown in FIG. 3A, the first container support 332 is angled at about 90 degrees relative to the second container support 334 such that the bracket is generally L-shaped. In such a configuration, the first and second container supports 332, 334 may couple to different sides of an insulated container, such as the insulated container 110 described previously. For example, the first container support 332 may couple to the sidewall 116a and the second container support 334 may couple to the bottom wall 116e of the insulated container 110.

The shape of the container supports 332, 334 can correspond to the shape of one or more features of the insulated container 110. For example, the shape of the container support 332 is similar to the shape of the depression 262 and the shape of the container support 334 is similar to the shape of the depression 264. As shown in FIGS. 3A-3B, the container support 332 has a first sidewall 352a, a second sidewall 352b, and a third sidewall 352c. The first and second sidewalls 352a, 352b can be parallel to each other or, in some variations, can be angled relative to each other. In an exemplary embodiment, a first end of each of sidewalls 352a, 352b can be closer together than a second end of each of sidewalls 352a, 352b. The first end of each of sidewalls 352a, 352b is adjacent to the rounded surface 355. The sidewalls 352a-352c are configured to align with the sidewalls 252a-252c, such that the container support can slot into the depression 262 in a dovetail manner. As further shown in FIGS. 3A-3B, the container support 334 has a first sidewall 354a, a second sidewall 354b, and a third sidewall 354c. The first and second sidewalls 354a, 354b can be parallel to each other or, in some variations, can be angled relative to each other. In an exemplary embodiment, a first end of each of sidewalls 354a, 354b can be closer together than a second end of each of sidewalls 354a, 354b. The first end of each of sidewalls 354a, 354b is adjacent to the rounded surface 355. The sidewalls 354a-354c are configured to align with the sidewalls 254a-254c, such that the container support can slot into the depression 264 in a dovetail manner.

FIGS. 4A and 4B further illustrate the axle housing 320 and bracket 330. For example, the bracket 330 is shown coupled to an inner surface of the axle housing 320. The bracket 330 is centered along a length of the axle housing 320, where the length defines a dominant dimension of the axle housing 320. The central positioning of the bracket 330 relative to the length of the axle housing 320 may facilitate equal weight distribution of an insulated container (not shown) to each of the wheels (not shown) that may be coupled to the axle housing 320. The first container support 332 has a first primary surface 418 and a top edge 410. The primary surface 418 and/or the top edge 410 may be configured to contact an insulated container. The second container support 334 has a second primary surface 419. The second primary surface 419 may similarly be configured to contact an insulated container.

One or more of the container supports 332, 334 can have one or more openings (e.g., through holes). Each of the one or more openings may be configured to receive a fastener, such as a screw, a nail, a bolt, a rope, a tie, or a combination thereof. In an exemplary variation, the first container support 332 has a first plurality of openings 412 and the second container support 334 has a second plurality of openings 414. In the illustrated embodiment, the first plurality of openings 412 comprises two openings and the second plurality of openings 414 comprises four openings. The illustrated first plurality of openings 412 are positioned along the upper edge 410 of the first container support 332. The upper edge 410 can have a depth corresponding to the depth, d, of the first depression 262 described in reference to FIG. 2C. The depth of the upper edge 410 may be greater than a diameter of each of the first plurality of openings 412, such that any fastener positioned therethrough remains securely within the respective opening of the first plurality of openings 412. In some variations, additionally or alternatively, one or more openings may be positioned on a first surface 418. The first and second plurality of openings 412, 414 may correspond to the openings of an insulated container. For example, the first plurality of openings 412 may correspond to the first plurality of openings 232 and second plurality of openings 414 may correspond to the second plurality of openings 232 described in reference to FIG. 2C. One or more fasteners may be positioned through the corresponding openings of each of the bracket 330 and the insulated container. Accordingly, the fasteners positioned through the plurality of openings 412, 232 may be parallel to the fasteners positioned through the plurality of openings 414, 234.

Fasteners positioned within the plurality of openings 412, 414 may facilitate transportation of the insulated container with the wheeled accessory securely coupled thereto. In other words, the fasteners may be configured to resist one or more forces associated with transportation of the insulated container. For example, the bracket 330 may experience a shear stress due to lateral movement of the insulated container, such as when the insulated container may be rolling across the ground via the wheels of the wheel assembly described herein. Accordingly, the fasteners used to couple to the bracket 330 to the insulated container may have a shear strength greater than the shear stress associated with the lateral movement of insulated container. In some variations, one or more fasteners may be positioned at any position of the wheel assembly in order to resist one or more forces including compressive, tensile, or shear forces.

In variations with a plurality of fasteners, each of the plurality of fasteners may be positioned in the same orientation as each other or in different orientations. For example, a first set of fasteners extending through the first plurality of openings 412 may be parallel to a second set of fasteners extending through the second plurality of openings 414. In such a configuration, each of the first and second sets of fasteners may primarily counteract shear stresses associated with vertical movement of the insulated container (e.g., when picking up or putting down the insulated container). In some variations, the first set of fasteners may be perpendicular to the second set of fasteners extending through the second set of openings. For example, the first set of fasteners may be positioned horizontally (e.g., parallel to the bottom wall 116e of the insulated container 110) while the second set of fasteners may be positioned vertically (e.g., perpendicular to the bottom wall 116e of the insulated container 110). In such a configuration, the first set of fasteners may primarily counteract shear stresses associated with vertical movement of the insulated container (e.g., when picking up or putting down the insulated container) while the second set of fasteners may primarily counteract shear stresses associated with horizontal movement of the insulated container (e.g., when pulling or pushing the insulated container across the ground).

The axle housing 320 can also have one or more openings configured to facilitate coupling the axle housing 320 to an insulated container without the bracket 330. For example, the illustrated axle housing 320 has a first side opening 450a and a second side opening 450b. Each of the first and second side openings 450a, 450b can be configured to receive a fastener. Accordingly, a user may releasably fasten the axle 320 to an insulated container using a fastener positioned with each of the first and second side openings 450a, 450b. Fasteners positioned within each of the first and second side openings 450a, 450b may be perpendicular to the fasteners positioned through the plurality of openings 412, 414 of the bracket 330. Advantageously, the different orientation facilitated by the various openings described herein may ensure the axle housing 320 withstands forces in any direction caused by movement of the portable storage system.

The axle housing can be configured to receive one or more axles. In particular, the axle housing can have one or more openings and/or lumens sized to receive the axle. For example, as shown in FIG. 4A, the axle housing 320 has a plurality of openings 434. Each of the openings 434 is defined in a rib 436 intended to provide structural integrity to the axle housing 320. That is, the ribs 436 may be positioned at locations associated with mechanical stresses (e.g., bending, twisting, deflecting), such that the axle housing 320 may withstand the mechanical stresses without breaking. The openings 434 may each have a diameter greater than a diameter of an axle, such as the axle 125 described in reference to FIG. 3B. Accordingly, an axle positioned within the openings 434 may freely rotate without significant friction between the openings 434 and the axle. The axle 125 may extend through each of the openings 434 in a manner parallel to a dominant longitudinal dimension of the axle housing 320. For example, the axle 125 may protrude from each of a first end of the axle housing and a second end of the axle housing. Therefore, the first wheel 122a may be coupled to a first end of the axle 125 and the second wheel 122b may be coupled to a second end of the axle 125, where the second end is opposite the first end. The openings 434 comprise a diameter greater than a diameter of the axle 125. Accordingly, the axle 125 may rotate freely within the axle housing 320.

The wheeled accessory described herein may include one or more features configured to be engaged by a user. For example, as indicated above, the wheeled accessory 101 can include a handle assembly 130 as shown in FIGS. 1A-1D. The illustrated handle assembly 130 has a third elongate member 134a, a fourth elongate member 134b, and a gripping member 136. The gripping member 136 may be configured as a handlebar and/or at least a portion of the gripping member 136 may include a surface texture configured increase a friction coefficient between the gripping member and a user. The gripping member 136 may be substantially linear. In some variations, the gripping member 136 may include one or more bends, such as in a L-shape, a V-shape, a U-shape, or a W-shape. The gripping member 136 may be fixedly coupled to the elongate members 134a, 134b, such that a user may apply significant force to the gripping member 136 without risk of detaching the gripping member 136 from the elongate members 134a, 134b. In some variations, the gripping member 136 may be releasably coupled to the elongate members 134a, 134b, such that a user may intentionally decouple one or more of the elongate members 134a, 134b from the gripping member 136 for repair, storage, or disassembly.

The handle assembly 130 can also include a mounting body configured to be releasably coupled to the insulated container. For example, the mounting body may utilize a friction fit to releasably couple to a side handle of the insulated container. FIGS. 5A and 5B illustrate a mounting body 162 having a first mounting protrusion 522a, a second mounting protrusion 522b, a third mounting protrusion 522c, and a fourth mounting protrusion 522d. Each of the mounting protrusions 522a-522d can be configured to releasably couple to a corresponding opening of the side handle 114. For example, the first mounting protrusion 522a may engage with the first mounting opening 226a, the second mounting protrusion 522b may engage with the second mounting opening 226b, the third mounting protrusion 522c may engage with the third mounting opening 226c, and the fourth mounting protrusion 522d may engage with the fourth mounting opening 226d. The mounting protrusions 522a-522d may be slid into the corresponding mounting openings 226a-226d, such that the components stay attached via friction. In some variations, any number of mounting protrusions can be utilized, or additional or alternative means of fastening may be used, such as bolts, screws, nails, adhesives, ropes, ties, or a combination thereof.

When mated to a container, the one or more elongate members of the handle assembly can be configured to rotate (e.g., pivot) relative to the side handle of the insulated container. In an exemplary variation, the third elongate member 134a and fourth elongate member 134b are coupled to the mounting body 162 via a pivot joint. In particular, the third elongate member 134a is coupled to a first pivot joint 154a and fourth elongate member 134b is coupled to a second pivot joint 154b. Each of the third and fourth elongate members 134a, 134b may be configured to rotate about a point of rotation (e.g., pivot point) defined by the respective pivot joints 154a, 154b. In some aspects, each of the third and fourth elongate members 134a, 134b may be configured to rotate between about 5 degrees and about 120 degrees relative to the mounting body 162. In some variations, the elongate members 134a, 134b may be configured to rotate between about 5 degrees and about 135 degrees, about 20 degrees and about 120 degrees, about 60 degrees and about 120 degrees, or about 85 degrees and about 95 degrees, including about 45 degrees, about 60 degrees, about 90 degrees, or about 120 degrees.

The ability to rotate the one or more elongate members may facilitate transferring the handle assembly from a stowed position, which may be referred to as a first configuration, to an extended position, which may be referred to as a second configuration. For example, the stowed position of the handle assembly may facilitate compact storage of the insulated container system. As another example, the extended position may facilitate pulling or pushing the insulated container by a user.

In some variations, the elongate members 134a, 134b may be extendable. For example, one or more portions of each of the elongate members 134a, 134b may be partially nested within another portion of the respective elongate member. Accordingly, the nested portion may extend in a lateral direction in response to a force, such as a user pulling on the nested portion. The extended portion may be subsequently pushed back or otherwise revert to the nested (e.g., stowed) position. Advantageously, the ability to extend and retract the elongate members described herein may facilitate compact storage of the wheel assembly.

Methods of attaching and/or detaching the wheeled accessory described herein are also provided. For example, a method of releasably coupling a wheeled accessory to a container can include attaching the elongate members 124a, 124b of the wheel assembly 102 to the first side handle 112 of the insulated container 110. In particular, the mounting protrusions 340a, 340b of the elongate member 124a can be pushed (e.g., by a user) into the corresponding mounting openings 222a, 222b, respectively, of the first side handle 112. In a similar fashion, the mounting protrusions 340c, 340d of the elongate member 124b can be pushed into the corresponding mounting openings 222c, 222d, respectively, of the first side handle 112.

The method may further include positioning a portion of a bracket in a depression of the insulated container. For example, the container supports 332, 334 of the bracket 330 can be positioned in the depressions 262, 264, respectively. In particular, the insulated container 110 can be turned upside down, such that the depression 264 is facing upwards (i.e., in a direction away from the ground). The container support 332 can be slotted into the depression 262 and the container support 334 can be slotted into (e.g., pushed into from above) the depression 264. The shapes of the depressions 262, 264 correspond to the shapes of container supports 332, 334 in a dovetail manner, such that the container supports 332, 334 stay in a desired position (e.g., in contact with the insulated container 110). That is, the container supports 332, 334 are prevented from moving laterally (e.g., in a direction parallel to the respective sidewalls of the insulated container) out of the respective depressions 262, 264. Thus, the container supports 332, 334 can only move in a vertical direction, such as when the insulated container 110 is in the upside-down position. Furthermore, positioning the container supports 332, 334 can further include aligning at least one opening of the container supports 332, 334 with at least one opening of the depressions 262, 264. For example, the openings 412 of the container support 332 can be aligned with the openings 232 of the depression 262 and/or the openings 414 of the container support 332 can be aligned with the openings 234 of the depression 264.

The method may further include fastening the wheel assembly 102 to the insulated container 110 with at least one fastener. For example, the axle housing 320 can be fastened to the insulated container 110 using fasteners inserted into the openings 450a, 450b. As another example, the container supports 332, 334 can be fastened to the insulated container 110 using fasteners inserted into the openings 412, 414 and 232, 234, respectively. The fasteners can prevent the container supports 332, 334 or any other portion of the wheel assembly 102 from unintentionally decoupling from the insulated container 110. In some variations, any of the fasteners described herein may be tightened by a user. For example, the user may reach into a cavity of the insulated container to facilitate tightening the fastener (e.g., by holding and/or tightening an end of the fastener). The cavity can be the same as the storage compartment, or it can be a separate portion of the insulated container. Advantageously, the fasteners may be positioned such that they avoid affecting any thermal insulation and/or waterproofing characteristics of the insulated container.

In some variations, the method may further include attaching the mounting body 162 of the handle assembly 130 to the second side handle 114 of the insulated container 110. In particular, the mounting protrusions 522a, 522b can be pushed into the corresponding mounting openings 226a, 266b, respectively, of the second side handle 114. In a similar fashion, the mounting protrusions 522c, 522d can be pushed into the corresponding mounting openings 226c, 266d, respectively, of the second side handle 114. The elongate members 134a, 134b can already be coupled to the mounting body 162, or, if not, can be easily coupled thereto by a user.

In some variations, the method may further include detaching the wheel assembly 102 from the insulated container 110. For example, the user can unfasten any fasteners used to couple the wheel assembly 102 to the insulated container 130. In another example, the user can pull out the mounting protrusions 340a-340d from the corresponding mounting openings 222a-222d. Accordingly, the wheel assembly 102 may be easily detached by the user. Optionally, the method may further include detaching the handle assembly 130 from the insulated container 110. For example, the user can pull out the mounting protrusions 522a-522d from the corresponding mounting openings 226a-226d. Accordingly, the handle assembly 130 may be easily detached by the user.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

What is claimed is:

1. A wheel assembly, comprising:
a first elongate member and a second elongate member, wherein a first end of each of the first and second elongate members is configured to couple to a first side handle of an insulated container; and
an axle assembly comprising:
an axle housing coupled to a second end of each the first and second elongate members;
an axle extending through the axle housing;
a first wheel coupled to a first end of the axle and a second wheel coupled to a second end of the axle; and
a bracket comprising a first container support configured to releasably couple to a first sidewall of the insulated container and a second container support configured to releasably couple to a bottom wall of the insulated container.

2. The wheel assembly of claim 1, wherein the first container support comprises a first set of openings and the second container support comprises a second set of openings.

3. The wheel assembly of claim 1, wherein the first set of openings are positioned along a top edge of the first container support.

4. The wheel assembly of claim 1 further comprising a handle assembly configured to releasably couple to a second side handle of the insulated container.

5. The wheel assembly of claim 4, wherein the handle assembly comprises a mounting body, a third elongate member, a fourth elongate member, and a gripping member.

6. The wheel assembly of claim 5, wherein a first end of each of the third and fourth elongate members is coupled to the mounting body, and wherein the mounting body is configured to releasably couple to the second side handle of the insulated container.

7. The wheel assembly of claim 5, wherein a second end of each the third and fourth elongate members is coupled to the gripping member.

8. The wheel assembly of claim 3, wherein each of the third and fourth elongate members is configured to rotate between about 5 degrees and about 120 degrees relative to the mounting body.

9. A portable storage system, comprising:
an insulated container comprising:
a first pair of sidewalls and a second pair of sidewalls, wherein an outer surface of a first sidewall of the first pair of sidewalls comprises a first depression at a bottom end of the first sidewall;
a bottom wall comprising an outer surface with a second depression, wherein the second depression is connected to the first depression; and
a first side handle extending from an upper portion of the first sidewall; and
a wheel assembly releasably coupled to the insulated container, the wheel assembly comprising:
an axle housing configured to releasably couple to the first and second depressions;
first and second elongate members that each extend from the axle housing and releasably couple to the first side handle; and
at least one wheel coupled to an axle extending through the axle housing.

10. The portable storage system of claim 9, further comprising a handle assembly releasably couple to a second side handle of the insulated container.

11. The portable storage system of claim 10, wherein the handle assembly comprises a mounting body, a third elongate member, a fourth elongate member, and a gripping member.

12. The portable storage system of claim 11, wherein a first end of each the third and fourth elongate members is coupled to the mounting body, and wherein the mounting body is releasably coupled to the second side handle of the insulated container.

13. The portable storage system of claim 11, wherein a second end of each the third and fourth elongate members is coupled to the gripping member.

14. The portable storage system of claim 11, wherein each of the third and fourth elongate members is configured to rotate between about 5 degrees and about 120 degrees relative to the mounting body.

15. The portable storage system of claim 9, wherein the at least one wheel comprises a first wheel coupled to a first end of the axle and a second wheel coupled to a second end of the axle.

16. The portable storage system of claim 9, wherein the axle housing comprises a bracket having a first container support releasably coupled to the first depression and a second container support releasably coupled to the second depression.

17. A portable storage system, comprising:
a container comprising:
a first pair of sidewalls and a second pair of sidewalls, wherein an outer surface of a first sidewall of the first pair of sidewalls comprises a first depression at a bottom end of the first sidewall;
a bottom wall comprising an outer surface with a second depression; and
a first side handle extending from an upper portion of the first sidewall; and
a wheel assembly releasably coupled to the insulated container, the wheel assembly comprising:
an axle housing comprising a bracket having a first container support releasably coupled to the first depression and a second container support releasably coupled the second depression, wherein the first container support comprises a first set of openings and the second container supports comprises a second set of openings;
at least one elongate member coupled to the first side handle; and
at least one wheel coupled to an axle extending through the axle housing.

18. The portable storage system of claim 17, wherein the plurality of openings of the first container support are positioned along an upper portion of the first container support.

19. The portable storage system of claim 17, wherein the first container support is perpendicular to the second container support.

20. The portable storage system of claim 17, further comprising a first set of fasteners extending through the first set of openings and a second set of fasteners extending through the second set of openings.

21. The portable storage system of claim 20, wherein the first and second sets of fasteners are parallel to each other.
